(19) United States
(12) Patent Application Publication
(10) Pub. No.: US 2015/0256049 A1
(43) Pub. Date: Sep. 10, 2015

(54) DRIVE UNIT FOR CHAIN DRIVES IN MINING

(71) Applicant: CATERPILLAR GLOBAL MINING EUROPE GMBH, Lünen (DE)

(72) Inventors: Adam Gacka, Witten (DE); Alexander Jänsch, Sudkirchen (DE); Andreas Scheer, Werne (DE); Dennis Grimm, Nordkirchen (DE); Jessica Johnson, Lunen (DE); Michael Nafe, Holzwickede (DE); Peter Pientka, Datteln (DE); Thomas Hoelken, Bergkamen (DE); Tobias Kleinbongartz, Dinslaken (DE)

(21) Appl. No.: 14/429,746

(22) PCT Filed: Sep. 12, 2013
(86) PCT No.: PCT/EP2013/002742

§ 371 Date: Mar. 19, 2015

(30) Foreign Application Priority Data
Sep. 19, 2012 (DE) 20 2012 103 587.1

(51) Int. Cl. H02K 7/116; H02K 11/00

(52) U.S. Cl. CPC H02K 7/116; H02K 11/0073

(57) ABSTRACT

The present disclosure refers to a drive unit for chain drives in mining. The drive unit may comprise at least one drive motor, a gearing unit coupleable to the drive motor, and a power supply housing provided with flange connections on its right and left sides. The at least one drive motor and the gearing unit both may be configured to be both connectable optionally on the right hand side or left hand side flange connection of the power supply housing. Further, a power supply unit housing supply assemblies for the drive motor and/or the gearing unit may be provided. The power supply unit may be mounted in the power supply housing.

### CROSS-REFERENCE TO RELATED APPLICATIONS

This application is a National Stage of International Patent Application No. PCT/EP2013/002742, filed Sep. 12, 2013, which claims priority to foreign German Patent Application No. 20 2012 103 587.1, filed Sep. 19, 2012, the contents of which are incorporated herein by reference in their entirety.

### TECHNICAL FIELD

The present disclosure in general relates to a drive unit for chain drives in mining More particularly, the present disclosure refers to a drive unit for chain drives configured for chain scraper conveyors or plough mining machinery. Particularly, such drive units may comprise at least one drive motor, a gearing unit which is or can be coupled to the drive motor, and a supply unit housing power supply assemblies for the drive motor and/or gearing unit.

### BACKGROUND

In mining extraction machines, more particularly longwall operating means such as conveyors and plough machinery which have traction chains, drive units are used which comprise high powered electric motors and gears flanged thereon. The gears with the, where necessary, associated clutches serve to introduce the high driving power of the motors into the drive shafts of the chain wheels of the machines which are to be driven. In underground mining, CST drive systems (Controlled Start Transmission) of modular construction have proved particularly suitable in which the actual gear stage which is mostly designed as a planetary or bevel wheel gearing with integrated coupling for starting up the machine is mounted in a first housing part and wherein the power supply assemblies such as cooling oil pump, high pressure pump, heat exchangers, hydraulic steering, filter or the like are mounted in a second housing part which forms a power supply unit.

The power supply unit is, in the case of the drives mentioned here, generally mounted between the drive motor and the gearing unit, wherein a drive shaft which connects the motor to the gearing unit passes through the power supply unit, and the power supply assemblies mounted in the power supply unit are arranged around the drive shaft. Accessibility to the power supply unit or to the operating elements for the power supply assemblies housed therein is as a result of their arrangement generally possible only from one side of the power supply unit. Depending on the location of the drive unit in the mining longwall or the gallery the position of the operating elements is then unfavourable which up until now meant for drives mounted on the right and left in the longwall at the ends of the longwall conveyor or mining plough that these were constructed individually for the relevant side and could not be exchanged from right to left.

The present disclosure is directed, at least in part, to improving or overcoming one or more aspects of prior systems.

### SUMMARY OF THE DISCLOSURE

In an aspect of the present disclosure a drive unit for chain drives in mining may comprise at least one drive motor, a gearing unit coupleable to the drive motor, and a power supply housing provided with flange connections on its right and left sides. The at least one drive motor and the gearing unit may be both connectable optionally on the right hand side or left hand side flange connection of the power supply housing. A power supply unit housing supply assemblies for the drive motor and/or the gearing unit may be provided. The power supply unit may be mounted in the power supply housing.

Accordingly, the power supply unit may be mounted in a power supply housing which is provided on the right and left side with flange connections. The drive motor and the gearing unit can both be optionally connected to the right or left hand flange connection of the power supply housing.

According to the present disclosure a drive unit as disclosed herein may improve a drive unit of the generic type to the extent that at low cost the drive unit remains operable from the same side both in the case of right and left connections of the drive motor to the power supply unit.

Other features and aspects of this disclosure will be apparent from the following description and the accompanying drawings.

### BRIEF DESCRIPTION OF THE DRAWINGS

Further features and advantages of the present disclosure are apparent from the following description and drawing in which a preferred embodiment of the present disclosure is illustrated and will be explained in further detail with reference to an example. The drawings show:

FIG. 1 a drive unit according to the present disclosure in perspective view wherein the drive motor for reasons of improved clarity is reduced to the illustration of the motor connecting flange;

FIG. 2 shows the subject of FIG. 1 in a front view; and

FIG. 3 shows in a perspective view a comparable illustration of the power supply unit of the drive according to the present disclosure wherein the motor connecting flange of the drive motor is flanged once on the right and once on the left side.

### DETAILED DESCRIPTION

In the drawings a drive unit is marked as a whole unit by 10, as used for chain drives of chain scraper conveyors or mining plough machinery used in underground mining.

The drive unit 10 consists essentially of a gearing unit 11, a drive motor 12 coupled to this, of which in the drawing for reasons of clarity only one motor connecting flange 13 is shown, as well as a power supply unit 14 which is mounted between the drive motor 12 and the gearing unit 11 and which serves for holding various different power supply assemblies such as by way of example a pump unit for supplying the gearing unit with hydraulic fluid, a pump drive motor for the pump unit, a throttle unit for supplying the gearing unit and/or the drive motor with cooling fluid and/or an electro-hydraulic control, wherein the power supply assemblies are housed in the interior of the power supply unit and can therefore not be seen from the outside of the power supply unit.

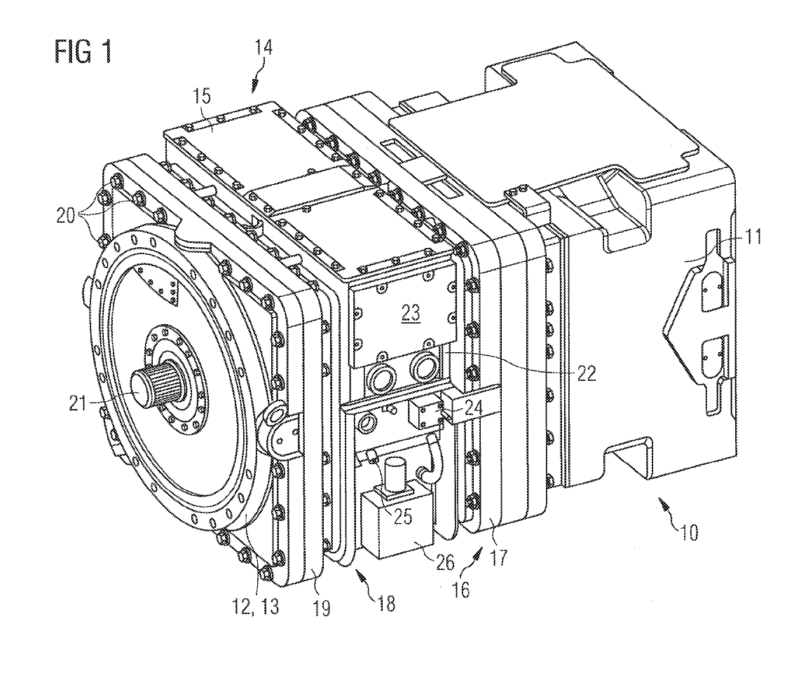

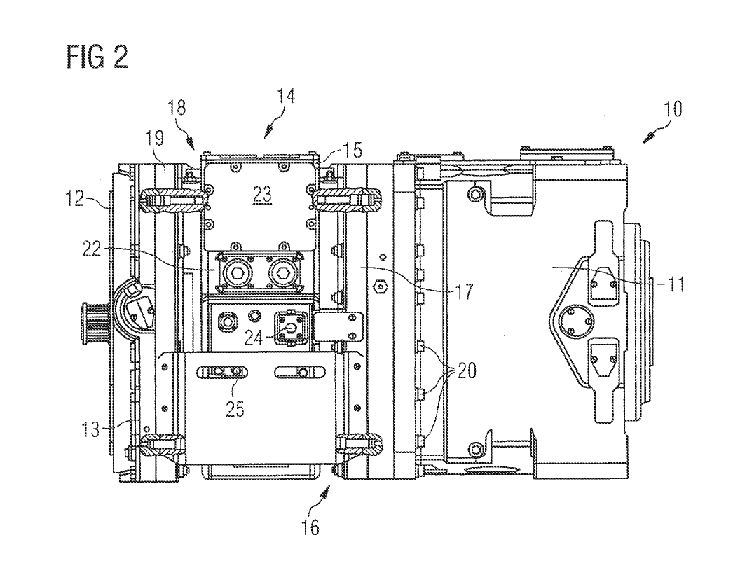

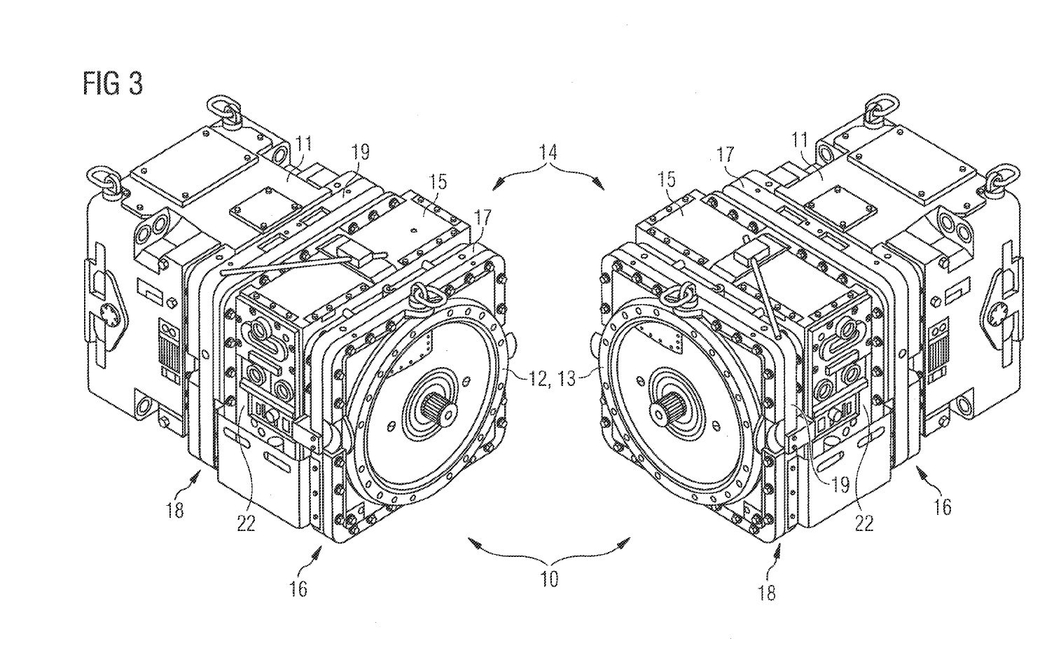

According to the present disclosure the power supply unit 14 is mounted in a power supply housing 15 which has on its right side 16 a first flange connection 17 and on its left side 18 a second flange connection 19. The two flange connections 17, 19 are identical in their hole pattern for fastening screws 20 and also their other configuration and are thus suitable for attaching both the drive motor 12 and also the gearing unit 11 thereon. With the construction illustrated in FIGS. 1 and 2 as well as in the right hand half of the drawing in FIG. 3, the motor connecting flange 13 of the drive motor 12 is connected each on the left side 18 of the power supply housing 15, thus on the second (left) flange connection 19, whilst the gearing unit 11 is located on the first flange connection 17 on the right hand side 16 of the power supply housing 15. In the assembled state an input shaft of the gearing unit 11, of which an end 21 can be seen in the drawing projecting slightly out from the motor connecting flange 13, passes through the power supply housing 15. This is provided, on a front peripheral side 22 between the left hand side flange connection 17 and the right hand flange connection 19, with a control and operating unit 23, shown in simplified form, with which the power supply assemblies mounted inside the power supply housing can be monitored and/or operated. Underneath the control and operating unit 23 there is on the peripheral side 22 a first pipeline connection 24 for a cooling fluid supply and a second pipeline connection 25 for a cooling fluid outflow in order to be able to supply cooling fluid to a heat exchanger mounted in the power supply housing, and to remove it therefrom again. Underneath the pipeline connections 24, 25 can finally be seen in FIG. 1 a part of a pump drive motor 26, which serves for driving a pump unit which is mounted inside the power supply housing and which supplies the gearing unit with hydraulic pressurised fluid.

From the comparison illustration in FIG. 3 it can readily be seen that the drive motor can be mounted with its motor connecting flange 13 both on the left side and also on the right side of the power supply housing, just as the gearing unit can also be flanged on the right or left side on the power supply housing. The power supply housing is thus a reversible housing in which the control and operating unit and the connections for the cooling fluid are always located on the same (front) peripheral side 22 independently of whether the drive motor is mounted left or right and the gearing unit is located right or left on the drive unit. A universally usable power supply unit is thus provided for the drives which are used in longwall or gallery mining and thus guarantees irrespective of the arrangement of the motor and gearing unit the good accessibility required for the operating elements and connections.

### INDUSTRIAL APPLICABILITY

According to the present disclosure the power supply unit might be thus mounted in a power supply housing which is designed as a reversible housing whose special feature may lie in the fact that it has right and left hand flange connections which are suitable and intended for connecting both the drive motor and also the gearing unit. The drive motor and gearing unit can therefore be flanged each on the left or the right side on the power supply housing which accommodates the power supply unit, wherein the operating elements, which are accessible outside on the power supply housing, might be located in relation to the drive motor one time on the left side and another time on the right side.

A drive shaft of the drive motor and/or an input shaft of the gearing unit preferably pass through the power supply housing at least in part. Naturally the coupling between the drive motor and gearing unit can also be achieved by a separate shaft member which is coupled on one side to the output shaft of the drive motor and on the other side to the input shaft of the gearing unit.

According to an exemplary embodiment of the present disclosure the power supply housing may have on a peripheral side between the right and left hand flange connection at least one control and/or operating unit so that any necessary adjusting work and/or reading of operating states by the miner can always be carried out on just this peripheral side of the power supply housing.

Another exemplary embodiment of the present disclosure may include a power supply housing configured to hold a pump unit for supplying the gearing unit with hydraulic pressurised fluid, a pump drive motor for the pump unit, a throttle unit for supplying the gearing unit and/or drive motor with cooling fluid and/or an electro-hydraulic control. A very compact method of construction of the complete drive unit is obtained with the minimum number of connections by way of example for a cooling fluid supply and outflow. It might be thereby particularly advantageous if the power supply housing is provided on a peripheral side between the right and left hand flange connection with pipeline connections for the cooling fluid supply and outflow.

Furthermore it might be advantageous if the power supply and/or operating connections for the drive motor and/or the gearing unit are provided both on the right and left sides or can be switched over internally from the right to the left side and vice versa. When changing the drive unit from a left to a right hand arrangement of the drive motor and a right to left hand arrangement of the gearing unit then only a minimum amount of conversion work is necessary at the power supply unit by quickly switching over the power supply and/or operating connections or even hardly any conversion work at all in the case of their redundant arrangement both on the left and on the right side.

It might also proved expedient if connections and operating elements which are accessible and/or operable from the outside of the power supply housing are all arranged on one and the same side wall of the power supply housing. With all these the power supply housing is preferably designed as a substantially one-piece housing whereby it can be manufactured simply and economically and has a high stability.

Although the preferred embodiments of this present disclosure have been described herein, improvements and modifications may be incorporated without departing from the scope of the following claims.

1. A drive unit for chain drives in mining, comprising:
at least one drive motor;
a gearing unit coupleable to the drive motor;
a power supply housing provided with flange connections on its right and left sides, the at least one drive motor and the gearing unit being both connectable optionally on the right hand side or left hand side flange connection of the power supply housing; and
a power supply unit housing supply assemblies for the drive motor and/or the gearing unit, the power supply unit being mounted in the power supply housing.

2. The drive unit according to claim 1, further comprising an output shaft of the drive motor and/or an input shaft of the gearing unit, the output shaft and/or the input shaft pass/es through the power supply housing at least in part.

3. The drive unit according to claim 1, further comprising at least one control and/or operating unit, the power supply housing being provided on a peripheral side between the right and the left flange connection with the at least one control and/or operating unit.

4. The drive unit according to claim 1, the power supply housing housing a pump unit for supplying the gearing unit with hydraulic pressurised fluid, a pump drive motor for the pump unit, a throttle unit for supplying the gearing unit and/or the drive motor with cooling fluid and/or an electro-hydraulic control.

5. The drive unit according to claim 1, the power supply housing being provided on a peripheral side between the right and left hand flange connections with pipeline connections for cooling fluid supply and outflow.

6. The drive unit according to claim 1, further comprising supply and/or operating connections for the drive motor and/or gearing unit, the supply and/or operating connections being provided both right and left on the power supply housing.

7. The drive unit according to claim 1, further comprising supply and/or operating connections for the drive motor and/or gearing unit, the supply and/or operating connections being configured to be switched over internally from the right side to the left side and vice versa.

8. The drive unit according to claim 1, wherein connections and/or operating units which are accessible and/or operable from the outside of the power supply housing are all arranged on one and the same side wall of the power supply housing.

9. The drive unit according to claim 1 wherein the power supply housing is designed as a substantially one-piece housing.
